(19) United States
(12) Patent Application Publication
(10) Pub. No.: US 2021/0192341 A1
(43) Pub. Date: Jun. 24, 2021

(54) LEARNING DEVICE, LEARNING METHOD, AND LEARNING PROGRAM

(71) Applicant: NIPPON TELEGRAPH AND TELEPHONE CORPORATION, Tokyo (JP)

(72) Inventors: Yu OYA, Musashino-shi, Tokyo (JP); Yasutoshi IDA, Musashino-shi, Tokyo (JP)

(73) Assignee: NIPPON TELEGRAPH AND TELEPHONE CORPORATION, Tokyo (JP)

(21) Appl. No.: 17/049,343

(22) PCT Filed: Apr. 11, 2019
(86) PCT No.: PCT/JP2019/015874

§ 371 Date: Oct. 21, 2020

(30) Foreign Application Priority Data
Apr. 24, 2018 (JP) 2018-083488

(51) Int. Cl. G06N 3/08; G06N 3/04

(52) U.S. Cl. CPC G06N 3/08; G06N 3/04

(57) ABSTRACT

A first calculation unit (121), for each of layers of a neural network, discretizes a parameter using a step function and then calculates an output signal. Further, a second calculation unit (122), for each of layers of a neural network, calculates a gradient of an error function of the output signal with respect to the parameter using a continuous function to which the step function is approximated. Further, an updating unit (123) updates the parameter on the basis of the gradient calculated by the second calculation unit (122).

### TECHNICAL FIELD

The present invention relates to a learning apparatus, a learning method, and a learning program.

### BACKGROUND ART

A deep neural network is a model that is used in various fields including image or voice recognition. A model is configured as a multi-layer neural network, and the neural network is configured of a plurality of perceptrons. This perceptron calculates a sum of products of a plurality of input signals with respective parameters called weights to obtain one value.

Further, the perceptron projects a value obtained using a non-linear function called an activation function to provide an input signal for a next layer, and outputs a signal value. This calculation is performed sequentially from an input layer to an output layer and a signal is transmitted, such that a prediction value can be obtained. This is forward propagation.

An optimal weight value needs to be prepared to obtain high prediction performance. Thus, a deep neural network can be solved as an optimization problem in which a parameter is a weight. Specifically, a model is learned from observation data so that an error function of a problem to be solved is minimized. A stochastic gradient descent method may be used for this minimization. In this stochastic gradient descent method, a gradient (slope) of an error with respect to a certain parameter is obtained such that it is possible to recognize in which direction the parameter is to be updated to reduce the error. This is error backward propagation.

In the related art, a scheme for binarizing a parameter and a signal value of a deep neural network into code information of +1 or −1 and compressing a memory consumption amount of a calculator is known (see, for example, NPL 1).

Further, when binarization is performed using a step function at the time of forward propagation, a gradient of an error function with respect to the parameter may be 0, and thus, updating of the parameter using error backward propagation cannot be performed. On the other hand, a scheme for regarding another function different from the step function used at the time of the forward propagation as having been used, and performing error backward propagation is known (see, for example, NPL 2).

### CITATION LIST

### Non Patent Literature

NPL 1: I. Hubara, M. Courbariaux, D. Soudry, R. El-Yaniv, and Y. Bengio, Binarized Neural Networks, “Advances in Neural Information Processing Systems”, pp. 4107-4115, 2016.
NPL 2: Y. Bengio, N. Leonard, and A. Courville, Estimating or propagating gradients through stochastic neurons for conditional computation, “arXiv preprint arXiv: 1308.3432”, 2013.

### SUMMARY OF THE INVENTION

### Technical Problem

However, a scheme of the related art has a problem in that it is difficult to improve the accuracy of learning while discretizing a parameter and an output signal at the time of forward propagation in a deep neural network.

For example, in a scheme of NPL 2, a step function is used at the time of forward propagation, whereas another function different from the step function at the time of the forward propagation is regarded as being used at the time of backward propagation and calculation of a gradient is performed. Thus, optimization of a parameter cannot be appropriately performed and the accuracy of learning cannot be improved in some cases.

### Means for Solving the Problem

In order to solve the problem described above and achieve the object, a learning apparatus of the present invention includes a first calculation unit configured to, for each of layers of a neural network, discretize a parameter using a step function and then calculate an output signal; a second calculation unit configured to, for each of layers of a neural network, calculate a gradient of an error function of the output signal with respect to the parameter using a continuous function to which the step function is approximated; and an updating unit configured to update the parameter on the basis of the gradient calculated by the second calculation unit.

### Effects of the Invention

According to the present invention, it is possible to improve the accuracy of learning while discretizing the parameter and the output signal at the time of the forward propagation in a deep neural network.

### BRIEF DESCRIPTION OF DRAWINGS

FIG. 1 is a diagram illustrating an example of a configuration of a learning apparatus according to a first embodiment.

FIG. 2 is a diagram illustrating an algorithm of a learning process according to the first embodiment.

FIG. 3 is a flowchart illustrating a flow of the learning process according to the first embodiment.

FIG. 4 is a flowchart illustrating a flow of a forward propagation process according to the first embodiment.

FIG. 5 is a flowchart illustrating a flow of a backward propagation process according to the first embodiment.

FIG. 6 is a diagram illustrating an example of a computer that executes a learning program.

### DESCRIPTION OF EMBODIMENTS

Hereinafter, embodiments of a learning apparatus, a learning method, and a learning program according to the present application will be described in detail with reference to the drawings. Note that the present disclosure is not limited to the embodiments described below.

### Configuration of First Embodiment

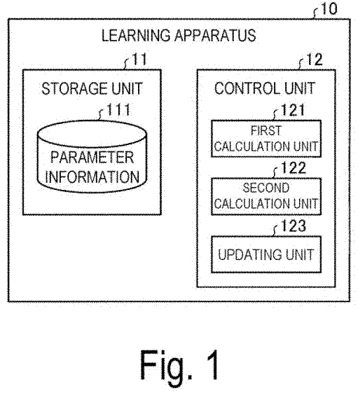

First, a configuration of a learning apparatus according to a first embodiment will be described with reference to FIG. 1. FIG. 1 is a diagram illustrating an example of a configuration of the learning apparatus according to the first embodiment. As illustrated in FIG. 1, a learning apparatus 10 includes a storage unit 11 and a control unit 12.

The storage unit 11 is a storage apparatus such as a hard disk drive (HDD), a solid state drive (SSD), and an optical disc. The storage unit 11 may be a semiconductor memory in which data can be rewritten, such as a random access memory (RAM), a flash memory, or a nonvolatile static random access memory (NVSRAM). The storage unit 11 stores an operating system (OS) or various programs that are executed by the learning apparatus 10. Further, the storage unit 11 stores various types of information to be used in the execution of the program. Further, the storage unit 11 stores parameter information 111, which is information of parameters to be used in a learning process.

The parameter information 111 includes, for example, a parameter for determining a weight of each of layers of a neural network, a parameter of a step function or a continuous function to be described below, and a hyperparameter to be used at the time of learning.

The control unit 12 controls the entire learning apparatus 10. The control unit 12 is, for example, an electronic circuit such as a central processing unit (CPU) or a micro processing unit (MPU), or an integrated circuit such as an application specific integrated circuit (ASIC) or a field programmable gate array (FPGA). Further, the control unit 12 includes an internal memory for storing a program defining various processing procedures or control data, and executes each process using the internal memory. Further, the control unit 12 functions as various processing units by various programs being operated. For example, the control unit 12 includes a first calculation unit 121, a second calculation unit 122, and an updating unit 123.

The first calculation unit 121 calculates a forward propagation portion of the neural network. The first calculation unit 121 discretizes a parameter using a step function and then calculates an output signal of each layer of the neural network. Further, the first calculation unit 121 can perform the discretization using a step function having an average deviation of the parameter as an upper limit and a value that is a negative version of the average deviation as a lower limit. In the following description, the parameter discretized by the first calculation unit 121 may be referred to as a weight.

The second calculation unit 122 performs a process in a backward propagation portion of the neural network. The second calculation unit 122 calculates a gradient of an error function of the output signal with respect to the parameter for each layer of the neural network using a continuous function to which the step function is approximated. Further, the second calculation unit 122 can approximate the step function to a function obtained by multiplying a continuous function with a range of the output value from 1 to −1 by an average deviation of the parameter. Further, the second calculation unit approximates the step function to a continuous function having the average deviation of the parameter as an upper limit and a value that is a negative version of the average deviation as a lower limit.

The updating unit 123 updates the parameter on the basis of the gradient calculated by the second calculation unit 122. Thus, the learning apparatus 10 performs a forward propagation process, a backward propagation process, and a parameter updating process to perform learning of the neural network.

Here, the forward propagation process, the backward propagation process, and the parameter updating process will be described in detail. First, in the forward propagation process, the first calculation unit 121 calculates a sum of products of a signal z⁽¹⁻¹⁾ input from a (1-1)-th layer with the weight. In this case, the first calculation unit 121 discretizes a parameter w⁽¹⁾ of a 1-th layer using a step function f (·) to calculate a weight b⁽¹⁾ of the 1-th layer. That is, the first calculation unit 121 calculates the weight using b⁽¹⁾=f(w⁽¹⁾). Further, the step function to be used in the forward propagation process may be a function of performing binarization such as with output values +1 and −1 or may be a function in which output values are a plurality of three or more values.

The first calculation unit 121 calculates an output signal z⁽¹⁾ of the 1-th layer according to Formulas (1-1) and (1-2).

$$[ Formula 1 ]$$

$$\begin{matrix}{h}_{j}^{( l )} = {\sum }_{i} ( {b}_{ji}^{( l )} {z}_{i}^{( l - 1 )} ) & ( 1 \text{-} 1 ) \\ {z}_{j}^{( l )} = f ( {h}_{j}^{( l )} ) & ( 1 \text{-} 2 )\end{matrix}$$

h⁽¹⁾ indicates an internal state of the neural network. Further, i and j are values for identifying a unit of a (1-1)-th layer and a unit of the 1-th layer, respectively. That is, bⱼᵢ⁽¹⁾ is a weight between an i-th unit of the (1-1)-th layer and a j-th unit of the 1-th layer. Further, zⱼ⁽¹⁾ is an output signal of the j-th unit of the 1-th layer.

In the backward propagation process, the second calculation unit 122 then calculates a gradient of an error function E with respect to the parameter w⁽¹⁾ for each layer of the neural network using Formulas (2-1) and (2-2).

$$[ Formula 2 ]$$

$$\begin{matrix}{δ}_{j}^{( l )} = {\sum }_{k} {δ}_{k}^{( l + 1 )} ( {b}_{kj}^{( l + 1 )} {f}^{′} ( {h}_{j}^{( l )} ) ) & ( 2 \text{-} 1 ) \\ \frac{\partial E}{\partial {w}_{ji}^{( l )}} = {δ}_{j}^{( l )} {z}_{i}^{( l - 1 )} {f}^{′} ( {w}_{ji}^{( l )} ) & ( 2 \text{-} 2 )\end{matrix}$$

In this case, the second calculation unit 122 approximates the step function f ( ) used in the forward propagation to a continuous function such as Formula (3) and then calculates the gradient.

$$[ Formula 3 ]$$

$$\begin{matrix}{b}_{ji}^{( l )} = f ( {w}_{ji}^{( l )} ) \\ = {m}^{( l )} tanh ( \frac{a}{{m}^{( l )}} {w}_{ji}^{( l )} )\end{matrix} \qquad ( 3 )$$

Here, a constant a in Formula (3) is a hyperparameter when a value in a neighborhood of 1 is to be provided to an arctanh function. Further, m⁽¹⁾ is an average deviation of the parameter w⁽¹⁾ in the 1-th layer. The average deviation is an average value when an absolute value of the parameter is taken. Further, the continuous function is not limited to that of Formula (3).

Here, it is possible to reduce an amount of consumption of a calculator memory by discretizing the parameter or the like, as described in NPL 1. However, when the parameter or the like is discretized, a difference of an internal state occurs compared with a case in which a continuous value is used without discretizing an original parameter or the like, resulting in degradation of accuracy.

Thus, in the learning apparatus 10 of the embodiment, it is possible to decrease a difference between an internal state Σᵢ(bⱼᵢ⁽¹⁾ zᵢ⁽¹⁻¹⁾) when the parameter has been discretized and Σᵢ(wⱼᵢ⁽¹⁾ zᵢ⁽¹⁻¹⁾) when the parameter has not been discretized, by approximating the step function to the continuous function, as in Formula (3).

Further, the first calculation unit 121, to introduce sparse regularization, sets the step function as in Formula (4) such that the average deviation gradually approaches zero. In this case, the first calculation unit 121 calculates the weight using b⁽¹⁾=g(w⁽¹⁾).

$$[ Formula 4 ]$$

$$\begin{matrix}{b}_{ji}^{( l )} \approx g ( {w}_{ji}^{( l )} ) \\ = \{ \begin{matrix}+ {m}^{( l )} , & if {w}_{ji}^{( l )} \geq {m}^{( l )} , \\ - {m}^{( l )} , & if {w}_{ji}^{( l )} \leq - {m}^{( l )} , \\ 0 , & otherwise .\end{matrix}\end{matrix} \qquad ( 4 )$$

### Algorithm of First Embodiment

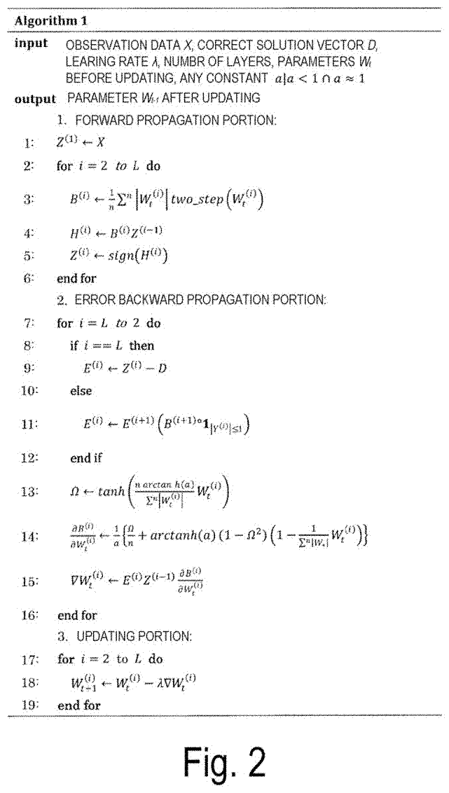

An algorithm of each of processes that are performed by the learning apparatus 10 will be described with reference to FIG. 2. FIG. 2 is a diagram illustrating an algorithm of a learning process according to the first embodiment.

As illustrated in FIG. 2, observation data X, a correct solution vector D, a learning rate λ, the number L of layers, a parameter Wₜ before updating, and any constant a (where a is about 1 and is smaller than 1) are input to the learning apparatus 10, and a parameter Wₜ₊₁ after updating is output. In FIG. 2, i is assumed to be a value for identifying each of layers.

First, the first calculation unit 121 calculates output signals of the first layer to an L-th layer (1. Forward propagation portion, lines 1 to 6). Here, the first calculation unit 121 uses the output signal of the first layer as the observation data X (line 1). Further, the first calculation unit 121 discretizes a parameter Wₜ⁽ⁱ⁾ before updating of each layer using a step function two_step (·) (line 3).

The step function two_step (·) may be g ( ) in Formula (4). Further, the first calculation unit 121 uses a value obtained by discretizing an internal state H⁽ⁱ⁾ using the step function sign(·) as an output signal Z⁽ⁱ⁾ (line 5).

Then, the second calculation unit 122 calculates an error function of the L-th layer to the 1-th layer (2. Backward propagation portion, lines 7 to 16). Here, the second calculation unit 122 calculates an error function of the L-th layer, that is, a last layer from the correct solution vector D and an output signal Z^{(L)} of the last layer (line 7).

The second calculation unit 122 approximates the step function two_step (·) to the continuous function, performs replacement, and then performs calculation of ∂B⁽ⁱ⁾/∂Wₜ⁽ⁱ⁾ of each layer (lines 13 and 14). In this case, the continuous function may be f (·) of Formula (3). Further, the second calculation unit 122 calculates a gradient ∇Wₜ⁽ⁱ⁾ of the error function with respect to the parameter (line 15).

The updating unit 123 updates the parameter of the 1-th layer to the L-th layer (3. Updating portion, lines 17 to 19). Specifically, the updating unit 123 subtracts an updating amount λ∇Wₜ⁽ⁱ⁾ from the parameter Wₜ⁽ⁱ⁾ before updating to calculate a parameter Wₜ₊₁⁽ⁱ⁾ after updating.

### Processing in First Embodiment

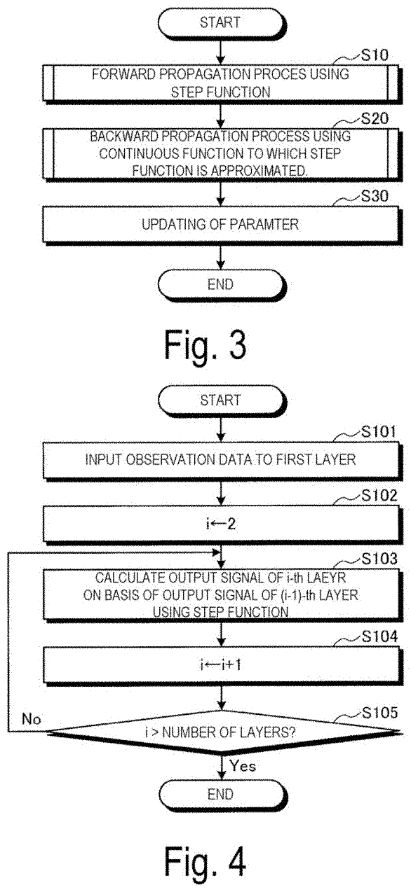

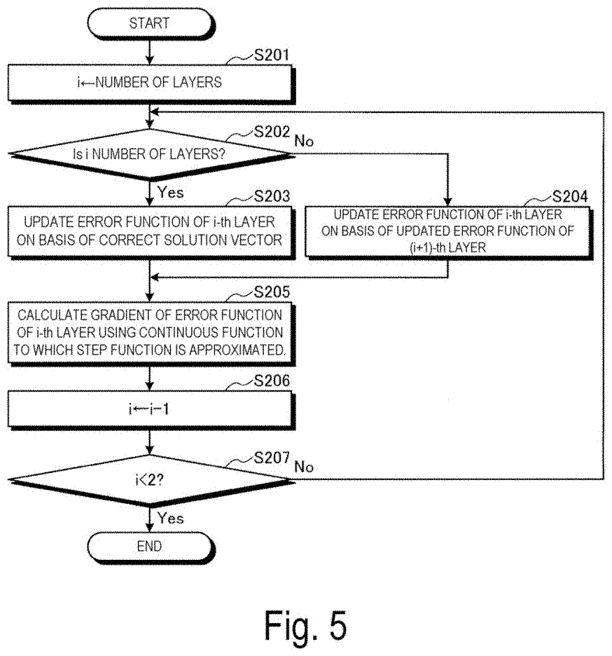

A flow of a process of the learning apparatus 10 will be described with reference to FIG. 3. FIG. 3 is a flowchart illustrating a flow of a learning process according to the first embodiment. First, the learning apparatus 10 performs the forward propagation process (which will be described below in detail with reference to FIG. 4) using a step function, as illustrated in FIG. 3 (step S10). The learning apparatus 10 then performs the backward propagation process (which will be described below in detail with reference to FIG. 5) using the continuous function to which the step function is approximated (step S20). The learning apparatus 10 performs updating of the parameter on the basis of the gradient of the error function obtained as a result of the backward propagation process (step S30).

A flow of the forward propagation process will be described with reference to FIG. 4. FIG. 4 is a flowchart illustrating the flow of the forward propagation process according to the first embodiment. First, the first calculation unit 121 inputs the observation data to the first layer, as illustrated in FIG. 4 (step S101). The first calculation unit 121 then assigns 2 to i (step S102).

The first calculation unit 121 calculates an output signal of an i-th layer on the basis of an output signal of an (i−1)-th layer using the step function (step S103). Here, the first calculation unit 121 increases i by one (step S104).

Here, when i is greater than the number of layers (step S105: Yes), the first calculation unit 121 ends the forward propagation process. On the other hand, when i is not greater than the number of layers (step S105: No), the first calculation unit 121 returns to step S103 to repeat the process.

A flow of the backward propagation process will be described with reference to FIG. 5. FIG. 5 is a flowchart illustrating a flow of the backward propagation process according to the first embodiment. First, the second calculation unit 122 assigns the number of layers (step S201) to i, as illustrated in FIG. 5.

Here, when i is the number of layers (step S202: Yes), the second calculation unit 122 updates the error function of the i-th layer on the basis of the correct solution vector (step S203). The i-th layer in this case is a last layer. On the other hand, when i is not the number of layers (step S202: No), the second calculation unit 122 updates the error function of the i-th layer on the basis of the updated error function of the (i+1)-th layer (step S204).

The second calculation unit 122 calculates the gradient of the error function of the i-th layer using the continuous function to which the step function is approximated (step S205). Further, the second calculation unit 122 decreases i by one (step S206).

Here, when i is smaller than 2 (step S207: Yes), the second calculation unit 122 ends the backward propagation process. On the other hand, when i is not smaller than 2 (steps S207: No), the second calculation unit 122 returns to step S202 to repeat the process.

### Effect of First Embodiment

In the embodiment, the first calculation unit 121 calculates the output signal of each layer on the neural network after discretizing the parameter using the step function. Further, the second calculation unit 122 calculates the gradient of the error function of the output signal with respect to the parameter for each layer of the neural network using the continuous function to which the step function is approximated. Further, the updating unit 123 updates the parameter on the basis of the gradient calculated by the second calculation unit 122. Thus, it is possible to improve the accuracy of learning, by performing replacement with the continuous function to which the step function used in the forward propagation is approximated and then performing the error backward propagation, while discretizing the parameter and the output signal at the time of the forward propagation.

The first calculation unit 121 can perform the discretization using the step function having the average deviation of the parameter as the upper limit and the value that is the negative version of the average deviation as the lower limit. Further, in this case, the second calculation unit approximates the step function to the continuous function having the average deviation of the parameter as an upper limit and a value that is a negative version of the average deviation as a lower limit. This allows scaling of the continuous function conforming to a range of the parameter.

Further, in this case, it is possible to minimize a difference between the output signals in a case in which the continuous function is used, a case in which a discrete function is used, and a case in which no function is used, by setting the initial value of the parameter to a minute value. The case in which no function is used is a case in which the parameter is used as a weight as it is. Further, this makes it possible to reduce an influence on optimization of a straight-through estimator (see NPL 2), which uses g ( ) at the time of forward propagation and f ( ) at the time of error backward propagation.

Further, in this case, the second calculation unit 122 can approximate the step function to a function obtained by multiplying a continuous function with a range of the output value from 1 to −1 by an average deviation of the parameter. This makes it possible to set the continuous function using, for example, tan h useful as an approximation function.

System Configuration and Others

Further, each illustrated component of each apparatus is functional and does not necessarily need to be physically configured as illustrated in the drawing. That is, a specific form of distribution and integration of the respective apparatuses is not limited to a form illustrated in the drawings, and all or some of the apparatuses can be distributed or integrated functionally or physically in any units according to various loads, and use situations. Further, all or any part of each processing function to be performed in each apparatus can be realized by the CPU and a program being analyzed and executed by the CPU, or can be realized as hardware by wired logic.

In addition, all or some of the processes described as being performed automatically among the processes described in the present embodiment can be performed manually, or all or some of the processes described as being performed manually can be performed automatically by a known method. In addition, the processing procedures, control procedures, specific names, and information including various types of data and parameters illustrated in the above documents and drawings can be modified as desired except in the case of the special description.

Program

In an embodiment, the learning apparatus 10 can be implemented by installing a learning program for executing the learning process in a desired computer as packaged software or on-line software. It is possible to cause an information processing apparatus to function as the learning apparatus 10 by causing the information processing apparatus to execute the learning program, for example. Here, the information processing apparatus includes a desktop or laptop personal computer. In addition, as the information processing apparatus, a mobile communication terminal such as a smart phone, a mobile phone, and a Personal Handyphone System (PHS), or a smart terminal such as Personal Digital Assistant (PDA) are included in the category.

Further, the learning apparatus 10 can be implemented as a learning server apparatus that provides services regarding the learning process to a client, which is a terminal apparatus that is used by a user. For example, the learning server apparatus is implemented as a server apparatus that provides a learning service in which an input is a parameter before updating and an output is a parameter after updating. In this case, the learning server apparatus may be implemented as a web server or may be implemented as a cloud that provides services regarding the learning process through outsourcing.

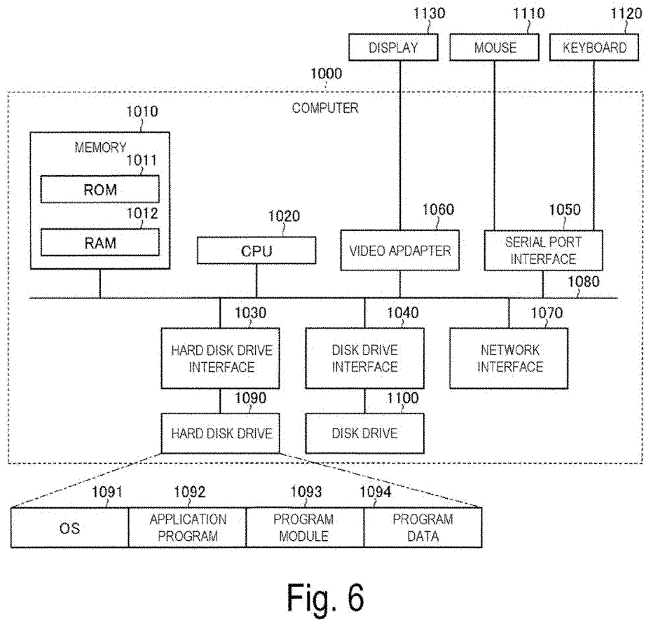

FIG. 6 is a diagram illustrating an example of a computer that executes a learning program. The computer 1000 has, for example, a memory 1010, and a CPU 1020. The computer 1000 also has a hard disk drive interface 1030, a disk drive interface 1040, a serial port interface 1050, a video adapter 1060, and a network interface 1070. These units are connected by a bus 1080.

The memory 1010 includes a Read Only Memory (ROM) 1011 and a RAM 1012. The ROM 1011 stores a boot program, such as Basic Input Output System (BIOS), for example. The hard disk drive interface 1030 is connected to a hard disk drive 1090. The disk drive interface 1040 is connected to the disk drive 1100. A removable storage medium, such as a magnetic disk or optical disk, for example, is inserted into the disk drive 1100. The serial port interface 1050 is connected to, for example, a mouse 1110 and a keyboard 1120. The video adapter 1060 is connected to the display 1130, for example.

The hard disk drive 1090 stores an OS 1091, an application program 1092, a program module 1093, and program data 1094, for example. That is, a program defining each of processes of the learning apparatus 10 is implemented as the program module 1093 in which computer-executable code has been described. The program module 1093 is stored, for example, in the hard disk drive 1090. For example, the program module 1093 for executing the same process as that of a functional configuration in the learning apparatus 10 is stored in the hard disk drive 1090. Note that the hard disk drive 1090 may be replaced with an SSD.

The configuration data used in the processing of the above-described embodiments is stored, for example, in the memory 1010 and the hard disk drive 1090 as the program data 1094. The CPU 1020 reads the program module 1093 and the program data 1094 stored in the memory 1010 and the hard disk drive 1090 into the RAM 1012 as necessary, and executes the processing of the above-described embodiments.

Note that the program module 1093 and the program data 1094 are not limited to being stored in the hard disk drive 1090, and may be stored, for example, in a removable storage medium, and read by the CPU 1020 via a disk drive 1100 or its equivalent. Alternatively, the program module 1093 and the program data 1094 may be stored in other computers connected via a network (a Local Area Network (LAN), and a Wide Area Network (WAN)). The program module 1093 and the program data 1094 may then be read by the CPU 1020 from other computers via the network interface 1070.

### REFERENCE SIGNS LIST

10 Learning apparatus
11 Storage unit
111 Parameter information
12 Control unit
121 First calculation unit
122 Second calculation unit
123 Updating unit

1. A learning apparatus comprising:
first calculation circuitry configured to, for each of layers of a neural network, discretize a parameter using a step function and then calculate an output signal;
second calculation circuitry configured to, for each of the layers of the neural network, calculate a gradient of an error function of the output signal with respect to the parameter using a continuous function to which the step function is approximated; and
updating circuitry configured to update the parameter on the basis of the gradient calculated by the second calculation circuitry.

2. The learning apparatus according to claim 1, wherein
the first calculation circuitry discretizes using the step function having an average deviation of the parameter as an upper limit and a value being a negative version of the average deviation as a lower limit, and
the second calculation circuitry approximates the step function to a continuous function having an average deviation of the parameter as an upper limit and a value being a negative version of the average deviation as a lower limit.

3. The learning apparatus according to claim 2, wherein the second calculation circuitry approximates the step function to the function obtained by multiplying a continuous function with a range of an output value from 1 to −1 by an average deviation of the parameter.

4. A learning method executed by a computer, the learning method comprising:
for each of layers of a neural network, discretizing a parameter using a step function and then calculating an output signal;
for each of the layers of the neural network, calculating a gradient of an error function of the output signal with respect to the parameter using a continuous function to which the step function is approximated; and
updating the parameter on the basis of the gradient calculated in the calculating of the gradient.

5. A learning program for causing a computer to function as the learning apparatus according to claim 1.
